(19) United States
(12) Patent Application Publication
(10) Pub. No.: US 2011/0085029 A1
(43) Pub. Date: Apr. 14, 2011

(54) VIDEO DISPLAY APPARATUS AND VIDEO DISPLAY METHOD

(75) Inventor: Akihiko Noguchi, Ome-shi (JP)

(73) Assignee: Kabushiki Kaisha Toshiba, Tokyo (JP)

(21) Appl. No.: 12/838,371

(22) Filed: Jul. 16, 2010

(30) Foreign Application Priority Data
Oct. 14, 2009 (JP) 2009-237614

(51) Int. Cl. H04N 13/04

(52) U.S. Cl. 348/58; 348/E13.075

(57) ABSTRACT

According to one embodiment, a video display apparatus includes a video generation module, a display mode changing module, a display, and a polarizing filter. The video generation module generates video including left-eye video and right-eye video by using video content data. The display mode changing module changes a display mode of a graphical user interface in the video from a first display mode to a second display mode. The display displays the video. The polarizing filter covering a screen of the display polarizes the displayed left-eye video and the displayed right-eye video.

### CROSS-REFERENCE TO RELATED APPLICATIONS

This application is based upon and claims the benefit of priority from Japanese Patent Application No. 2009-237614, filed Oct. 14, 2009; the entire contents of which are incorporated herein by reference.

### FIELD

Embodiments described herein relate generally to a video display apparatus and a video display method of viewing three-dimensional (3D) video.

### BACKGROUND

Conventionally, there is provided various video display apparatuses which enable viewing of 3D video. In such a video display apparatus, for example, a user is enabled to perceive 3D video (stereoscopic video) with use of left-eye video and right-eye video based on binocular parallax.

Jpn. Pat. Appln. KOKAI Publication No. 2007-114793 discloses a stereoscopic video display apparatus which displays stereoscopic video by a lenticular method and a barrier method. This stereoscopic video display apparatus can suppress a decrease in resolution or crosstalk of video due to the lenticular method and barrier method.

In the meantime, in a video display apparatus which enables viewing of 3D video by a polarization scheme, left-eye video and right-eye video are simultaneously displayed on the screen. The left-eye video and right-eye video are subjected to polarization in different directions through polarization filters. The user can view the polarized left-eye video by the left eye and the polarized right-eye video by the right eye by using polarized glasses. Thereby, the user can perceive the video, which is displayed on the screen, as stereoscopic video.

In the video display apparatus by the polarization scheme, the left-eye video and right-eye video are simultaneously displayed on the screen. For example, the pixels of left-eye video are displayed on odd-numbered scanning lines of the screen, and the pixels of right-eye video are displayed on even-numbered scanning lines of the screen. Specifically, a black scanning line, in which no video is displayed, is present in every second scanning line in each of the left-eye video and right-eye video. Consequently, for example, on a graphical user interface (GUI) including a fine object or text, it is possible that the difficulty in viewing, such as flickering of the screen, may occur.

### BRIEF DESCRIPTION OF THE DRAWINGS

FIG. 1 is an exemplary perspective view showing the external appearance of a video display apparatus according to an embodiment;

FIG. 2 is an exemplary block diagram showing the system configuration of the video display apparatus according to the embodiment;

FIG. 3 is an exemplary block diagram showing the functional structure of a content reproduction application executed by the video display apparatus according to the embodiment;

FIG. 4 shows an example of video including a GUI which is displayed on the screen by the video display apparatus according to the embodiment;

FIG. 5 shows an example of a GUI, the display mode of which is varied by the content reproduction application shown in FIG. 3;

FIG. 6 shows another example of the GUI, the display mode of which is varied by the content reproduction application shown in FIG. 3;

FIG. 7 shows still another example of the GUI, the display mode of which is varied by the content reproduction application shown in FIG. 3; and

FIG. 8 is an exemplary flowchart showing an example of the procedure of a video display process executed by the video display apparatus according to the embodiment.

### DETAILED DESCRIPTION

In general, according to one embodiment, a video display apparatus including: a video generation module configured to generate video including left-eye video and right-eye video by using video content data; a display mode changing module configured to change a display mode of a graphical user interface in the video from a first display mode to a second display mode; a display configured to display the video; and a polarizing filter covering a screen of the display and configured to polarize the displayed left-eye video and the displayed right-eye video.

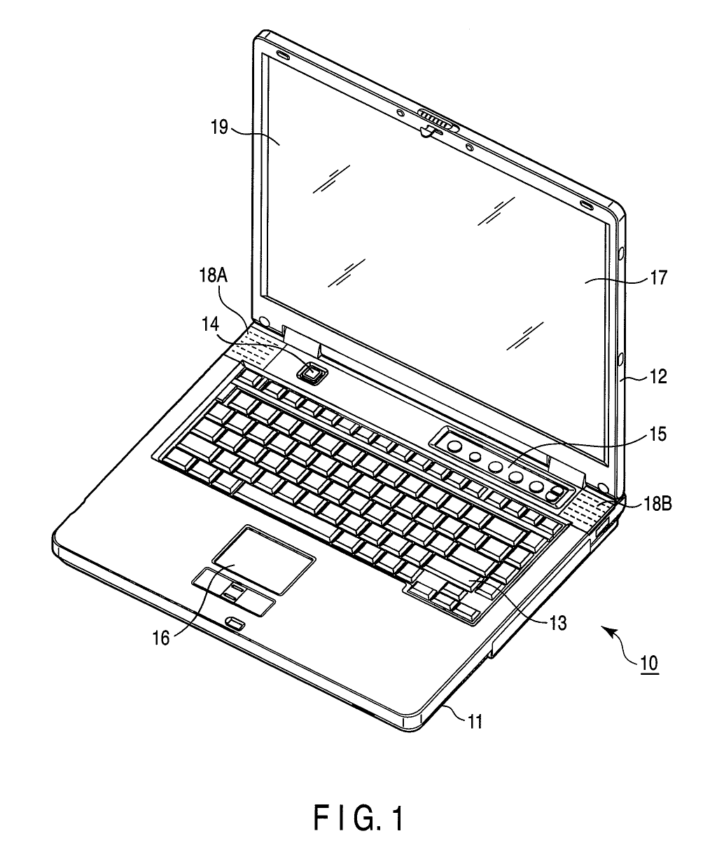

FIG. 1 is a perspective view showing the external appearance of a video display apparatus according to an embodiment. The video display apparatus is realized, for example, as a notebook-type personal computer 10. As shown in FIG. 1, the computer 10 includes a computer main body 11 and a display unit 12.

A liquid crystal display (LCD) 17 and a polarizing filter 19 are built in the display unit 12. The polarizing filter 19 is provided in a manner to cover the screen of the LCD 17. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power switch 14 for powering on/off the computer 10, an input operation panel 15, a touch pad 16, and speakers 18A and 18B are disposed on the top surface of the housing of the computer main body 11. Various operation buttons are provided on the input operation panel 15.

An external display connection terminal (not shown) corresponding to, e.g. the high-definition multimedia interface (HDMI) standard is provided on the back surface of the computer main body 11. The external display connection terminal is used for outputting a digital video signal to an external display.

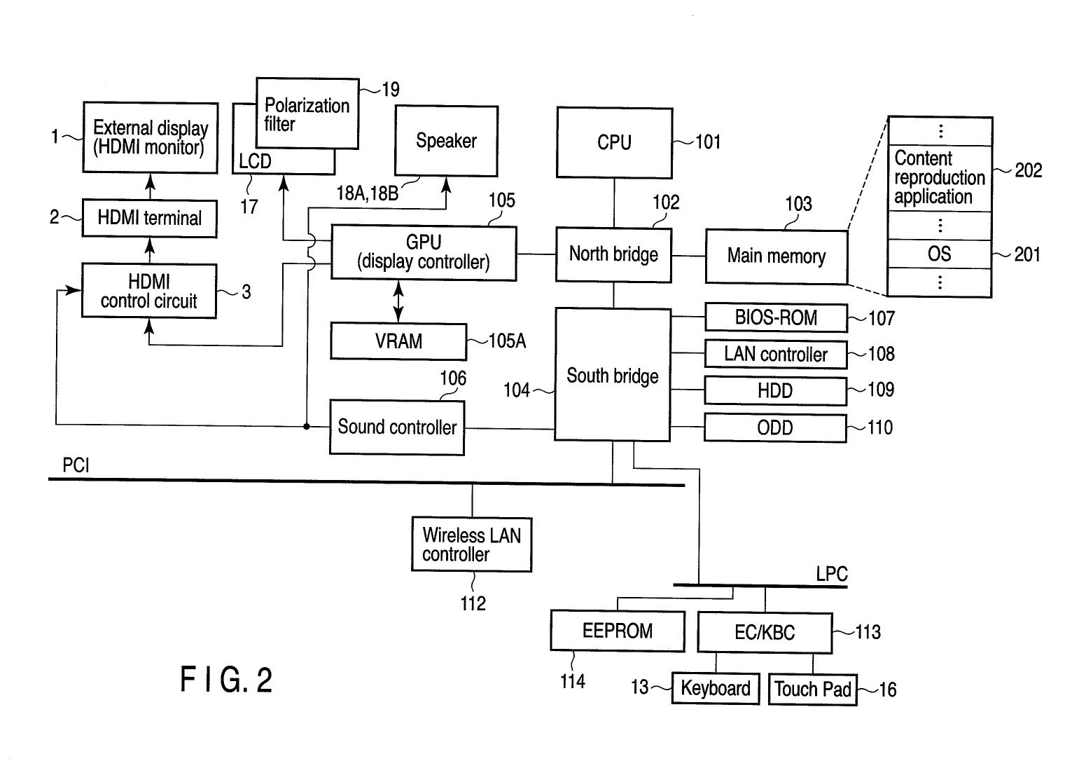

FIG. 2 shows the system configuration of the computer 10.

The computer 10, as shown in FIG. 2, includes a CPU 101, a north bridge 102, a main memory 103, a south bridge 104, a GPU 105, a VRAM 105A, a sound controller 106, a BIOS-ROM 107, a LAN controller 108, a hard disk drive (HDD) 109, an optical disc drive (ODD) 110, a wireless LAN controller 112, an embedded controller/keyboard controller (EC/KBC) 113, and an EEPROM 114.

The CPU 101 is a processor for controlling the operation of components in the computer 10. The CPU 101 executes an operating system (OS) 201 and various application programs, such as a content reproduction application program 202, which are loaded from the HDD 109 into the main memory 103. The content reproduction application program 202 is software for reproduce various digital contents stored in, e.g. the HDD 109. The content reproduction application program 202 also has a three-dimensional (3D) video reproduction function for reproducing 3D video content data. The 3D video reproduction function is, for example, a function of generating and displaying 3D video which can be viewed by, e.g. a polarization scheme. The 3D video is realized, for example, by causing a user to perceive left-eye video and right-eye video based on binocular parallax. The content data of 3D video is, for instance, 3D-capable video data in a DVD or video game. The video data includes, for example, data for left-eye video (video for left eye viewing) and data for right-eye video (video for right eye viewing). Using this video data, the content reproduction application program 202 generates a video signal of a video image that is to be displayed on the LCD 17.

Besides, the CPU 101 executes a BIOS stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of executing communication with the GPU 105 via, e.g. a PCI EXPRESS serial bus.

The GPU 105 is a display controller which controls the LCD 17 used as a display monitor of the computer 10. A display signal, which is generated by the GPU 105, is sent to the LCD 17. The LCD 17 displays video based on the display signal.

The polarizing filter 19 is a filter for polarizing a video image displayed on the LCD 17. The polarizing filter 19 is provided in a manner to cover the screen of the LCD 17, and polarizes the left-eye video and right-eye video. For example, the polarizing filter 19 polarizes, in different directions, odd-numbered scanning lines and even-numbered scanning lines from the top of the screen (LCD 17), and outputs polarized video. Specifically, the polarizing filter 19 is configured such that filters for polarization in different directions are alternately arranged in association with the odd-numbered scanning lines and even-numbered scanning lines.

In addition, the GPU 105 can send a digital video signal to an external display device 1 via an HDMI control circuit 3 and an HDMI terminal 2.

The HDMI terminal 2 is the above-described external display connection terminal. The HDMI terminal 2 is capable of sending a non-compressed digital video signal and a digital audio signal to the external display device 1, such as a TV, via a single cable. The HDMI control circuit 3 is an interface for sending a digital video signal to the external display device 1, 1, which is called “HDMI monitor”, via the HDMI terminal 2.

The south bridge 104 controls devices on a Peripheral Component Interconnect (PCI) bus and devices on a Low Pin Count (LPC) bus. The south bridge 104 includes an Integrated Drive Electronics (IDE) controller for controlling the HDD 109 and ODD 110. The south bridge 104 also has a function of executing communication with the sound controller 106.

The sound controller 106 is a sound source device and outputs audio data, which is to be reproduced, to the speakers 18A and 18B or the HDMI control circuit 3. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard.

The EC/KBC 113 is a One-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

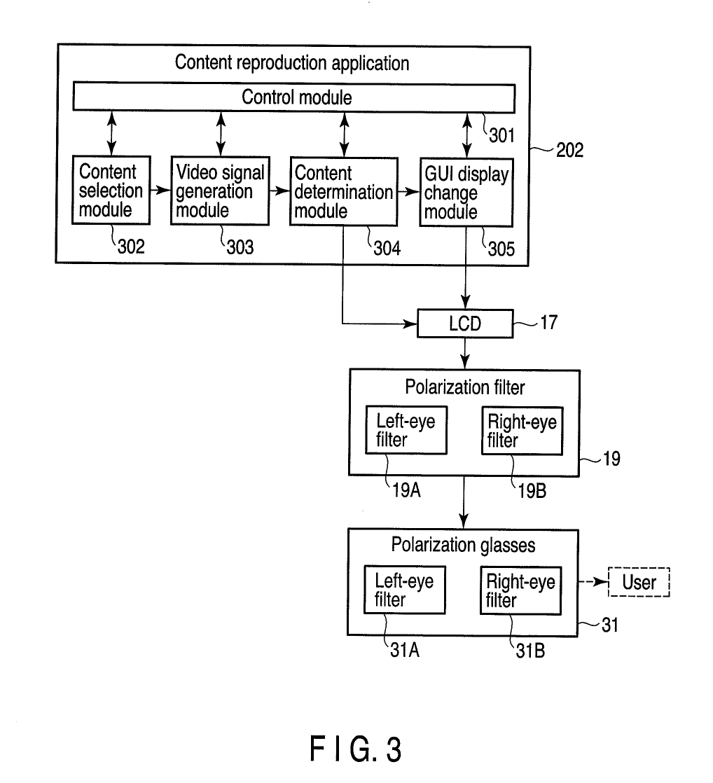

Next, referring to FIG. 3, a description is given of a functional structure of the content reproduction application program 202 which runs on the computer 10.

The content reproduction application program 202 includes a control module 301, a content select module 302, a video signal generation module 303, a content determination module 304, and a GUI display change module 305.

The control module 301 controls the operations of the respective components of the content reproduction application program 202. The content select module 302 selects video content data that is the target of reproduction (target video content data). The content select module 302 sets, for example, video content data designated through a GUI or the like by the user, as the target video content data. The content select module 302 reads the selected video content data from, e.g. the HDD 109, and outputs it to the video signal generation module 303.

Using the target video content data, the video signal generation module 303 generates a video signal of a video image that is to be displayed on the LCD 17. If the target video content data is video content data for displaying ordinary video (two-dimensional video content data), the video signal generation module 303 executes, e.g. a process of decoding compressed video data, and generates a video signal.

If the target video content data is video content data for displaying 3D video (3D video content data), the video signal generation module 303 generates, from the data, a video signal of a video image including left-eye video and right-eye video. The video image including left-eye video and right-eye video is, for example, such a video image that the pixels of left-eye video are displayed on odd-numbered scanning lines and the pixels of right-eye video are displayed on even-numbered scanning lines. Specifically, on the video image, a left-eye video component and a right-eye video component are alternately rendered in every other row. In the meantime, a video image may be generated by a method in which a left-eye video component and a right-eye video component are alternately rendered in every other column. The generated video includes video content which is provided as 3D video, and a GUI, such as text, a button or a window, which is provided as two-dimensional video. Since the video in the region corresponding to the GUI is two-dimensional video, the same (ordinary) video is used for the left-eye video and right-eye video.

The content determination module 304 determines whether the target video content data is 3D video content data. For example, based on video content data that is the target of reproduction or a generated video signal, the content determination module 304 determines whether the video content data is 3D video content data. In addition, the content determination module 304 determines whether the video content data is 3D video content data, for example, based on whether the content reproduction application 202 sets a video rendering method to be a method corresponding to a polarization scheme. Furthermore, the content determination module 304 may determine whether polarized eyeglasses 31 are in use or not, by detecting, with use of a camera (not shown) attached to the computer 10, whether the polarized glasses 31 are used or not, or by monitoring the presence/absence of the polarized eyeglasses 31 by using a pressure sensor-equipped polarized glasses holder. By any one of the above-described determination methods or by a combination of the above-described determination methods, the content determination module 304 determines whether the video content data is 3D video content data (i.e. whether the polarized eyeglasses 31 are in use or not). The content determination module 304 automatically switches the change/non-change of the display mode of the GUI, based on the determination result. In the meantime, there may be provided a function for manually setting, by the user, whether the video content data is 3D video content data.

If the target video content data is 3D video content data, the content determination module 304 outputs the video signal generated by the video signal generation module 303 to the GUI display change module 305. On the other hand, if the target video content data is not 3D video content data, the content determination module 304 outputs the video signal generated by the video signal generation module 303 directly to the LCD 17.

The GUI display change module 305 changes the display mode of the GUI, which is included in the video by the video signal generated by the video signal generation module 303, from a first display mode to a second display mode. Specifically, the GUI display change module 305 subjects the text, which is included in the GUI, to a process of changing the kind of font, a process of increasing the font size, and a process of changing the font to a boldface font. In addition, the GUI display change module 305 executes a process of increasing the display size of objects, such as a button, an icon, a slider, a mouse cursor, a caret, a menu, a window, a pop-up, etc. The GUI display change module 305 generates a video signal subjected to the above-described process of changing the display mode of the GUI. The GUI display change module 305 outputs the generated video signal to the LCD 17.

The GUI, which is to be subjected to the process of changing the display mode, may be all GUIs (objects, text, etc.) in the video, or may be only GUIs in a region which are assumed to attract the user's attention. The GUI display change module 305 sets, for example, the GUI in a window set in an active state, to be the target of change of the display mode.

The LCD 17 displays video based on the input video signal. If the target video content data is 3D video content data, for example, the pixels of left-eye video are displayed on odd-numbered scanning lines of the screen, and the pixels of right-eye video are displayed on even-numbered scanning lines of the screen.

The polarizing filter 19 polarizes the video displayed on the LCD 17. For example, the polarizing filter 19 polarizes, in a first direction, the video (left-eye video) which corresponds to the odd-numbered scanning lines, and polarizes, in a second direction, the video (right-eye video) which corresponds to the even-numbered scanning lines. Thus, the polarizing filter 19 includes a left-eye filter 19A at a position corresponding to the odd-numbered scanning lines, and a right-eye filter 19B at a position corresponding to the even-numbered scanning lines. The left-eye filter 19A and right-eye filter 19B polarize video in different directions. Specifically, the left-eye filter 19A polarizes the left-eye video in the first direction and the right-eye filter 19B polarizes the right-eye video in the second direction.

The polarized glasses 31 filter the polarized video and extract necessary video. The polarized glasses 31 include a left-eye filter 31A and a right-eye filter 31B. The left-eye filter 31A passes only the polarized left-eye video. On the other hand, the right-eye filter 31B passes only the polarized right-eye video. The user wears the polarized glasses 31 and views the polarized video, thus being able to capture the left-eye video by the left eye and the right-eye video by the right eye. In other words, by wearing the polarized glasses 31 and viewing the polarized video, the user can view 3D video.

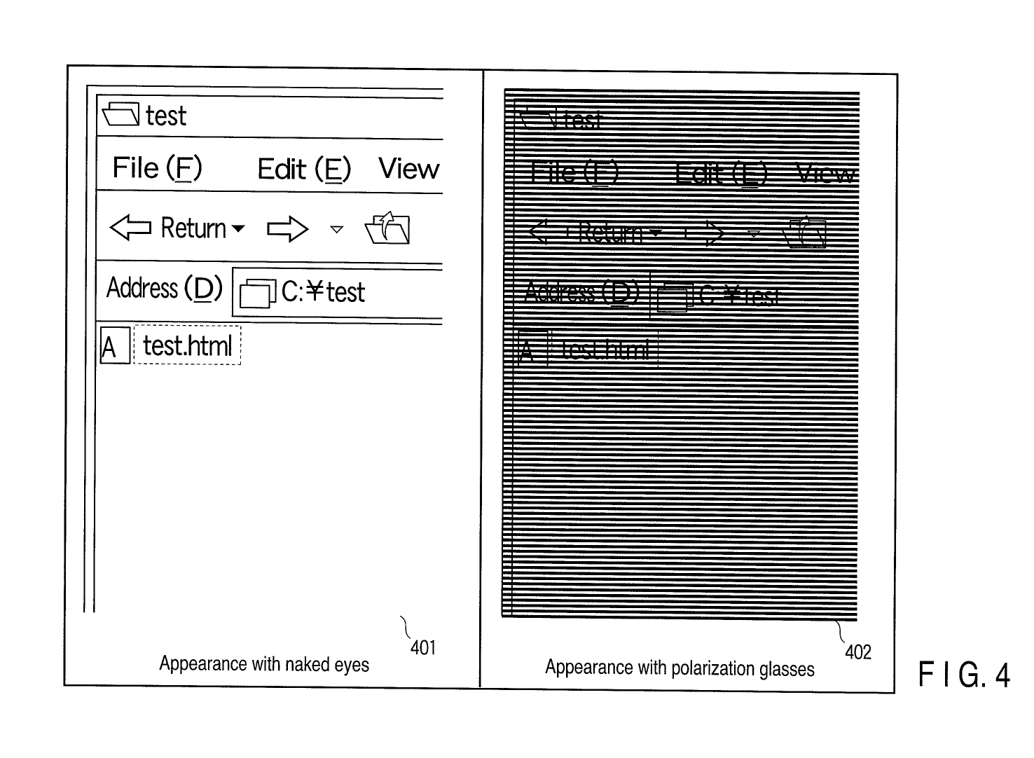

FIG. 4 to FIG. 7 show examples of video images output by the video display apparatus 10. In the description below, it is assumed that the target video content data is 3D video content data. Accordingly, the video image, which is output to the LCD 17, includes left-eye video and right-eye video. The video image, which is output to the LCD 17, is, for example, such a video image that the pixels of left-eye video are displayed on odd-numbered scanning lines and the pixels of right-eye video are displayed on even-numbered scanning lines.

FIG. 4 shows a screen 401 and a screen 402. The screen 401 is a screen in a case where video, which is displayed on the LCD 17 and polarized by the polarizing filter 19, is viewed by the naked eyes. The screen 402 is a screen in a case where the video is viewed by using the polarized eyeglasses 31. In this case, the screen 402 represents a screen which is captured by one of the left and right eyes with use of the polarized glasses (e.g. the screen based on the left-eye video, which is captured by the left eye).

The screen 401 in the case of view by the naked eyes is perceived like an ordinary planar (two-dimensional) video image. On the other hand, the screen 402, which is viewed with the polarized glasses 31, appears such that a black scanning line, at which no image is displayed, is present in every other row when the screen 402 is viewed by one eye. The reason for this is that the left-eye video, which is displayed on the odd-numbered scanning lines, is captured by the left eye and the right-eye video, which is displayed on the even-numbered scanning lines, is captured by the right eye. When the left-eye video and right-eye video are captured at the same time, 3D video can be perceived. However, since a black scanning line, at which no image is displayed, is present in every other row in each of the left-eye video and right-eye video (i.e. the resolution in the vertical direction is reduced to ½), such problems arise that the difficulty in viewing, such as flickering, occurs at a time of viewing small (fine) objects such as characters or icons, and that black horizontal lines are present on the entire screen. To address these problems, the content reproduction application 202 executes a process of changing the display mode so as to compensate the visibility of, e.g. the GUI operated by the user. The process of changing the display mode is, for example, a process of automatically increasing the size of objects, such as characters and icons, which are assumed to decrease in visibility when the polarized glasses 31 are used.

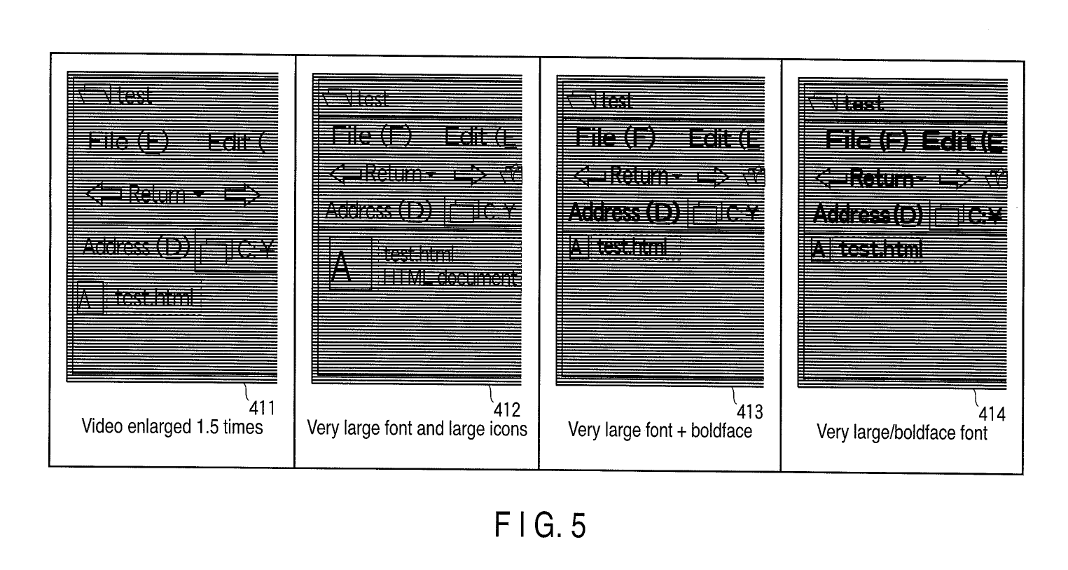

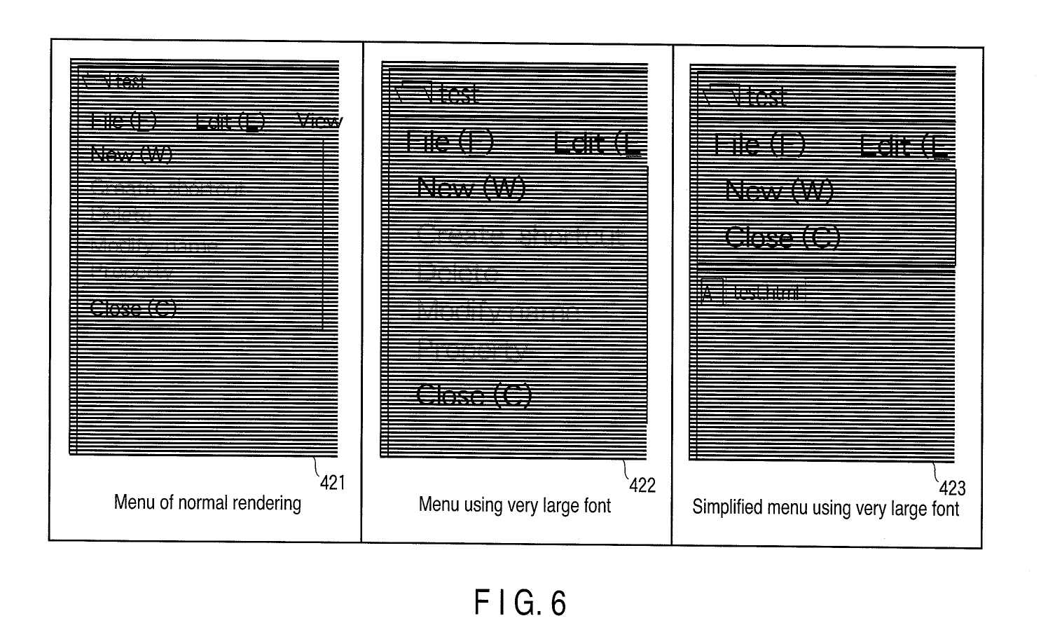

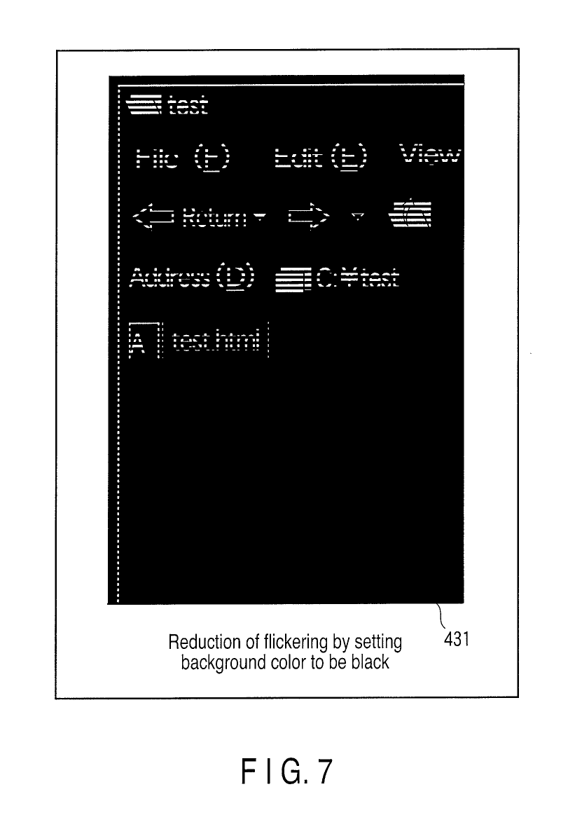

FIG. 5, FIG. 6 and FIG. 7 show examples of video images including GUIs, the display mode of which is changed by the content reproduction application 202. To begin with referring to FIG. 5, a description is given of examples of video which has been subjected to the process of varying the size of the GUI.

A screen 411 shows a video image in which the entire video is enlarged 1.5 times. On the screen 411, the entire video is enlarged, and thereby the GUI is also displayed in a larger size. Thus, the visibility of the GUI is improved. However, since the contents, etc. other than the GUI, are also displayed in an enlarged size, it is possible that the size of the entire video becomes greater than the screen size.

A screen 412 shows a video image in which the font size of text in the GUI is increased, and the size of icons is increased. On the screen 412, the text and icons are displayed in a larger size, and the visibility of the GUI is improved. In addition, since the contents, etc. other than the GUI, are unchanged in size, the size of the entire video does not greatly change.

A screen 413 shows a video image in which the font size of text in the GUI is increased, and the text is displayed in boldface. On the screen 413, the text is displayed in a large size and in boldface, and the visibility of the GUI is improved. In addition, like the screen 412, since the contents, etc. other than the GUI, are unchanged in size, the size of the entire video does not greatly change.

A screen 414 shows a video image in which the font size of text in the GUI is increased, and the kind of font is changed to a thick-line (boldface) font. On the screen 414, the text is displayed in a large size and in a thick-line font, and the visibility of the GUI is improved. In addition, like the screen 412, since the contents, etc. other than the GUI, are unchanged in size, the size of the entire video does not greatly change.

The content reproduction application 202 changes the display mode of the GUI, as described above, if the video content data is 3D video content data. The changes of the GUI display mode, which are shown in the screen 411 and screen 412, can easily be applied to video. However, depending on the content of video, it is possible that uniformity is lost in the design of video (the layout of objects in video), or that necessary information fails to be contained within the screen. Thus, the content reproduction application 202 selectively uses one of the GUI display change processes shown in the screens 411 to 414. Besides, the content reproduction application 202 may use, in combination, the GUI display change processes shown in the screens 411 to 414.

FIG. 6 is a view for describing a screen 423 including a simplified GUI. As shown in FIG. 5, when the size of display of text and various objects is increased, the region necessary for displaying the GUI increases. For example, a screen 421 displays a menu including a plurality of items. The content reproduction application 202 subjects the screen 421 to a process of increasing the font size of text, thus generating a screen 422. On the screen 422, since the font size of text is increased, the visibility of the GUI is improved. However, if the size of the GUI, such as text and icons, is increased, it is possible that the region of the screen, which is necessary for rendering the GUI, cannot be secured. For example, if the size of the entire screen displayed by the content reproduction application 202 is fixed, or if it is assumed that the display is maximized in use, the size of the region necessary for displaying, e.g. a menu including plural items increases, and it is possible that the menu cannot be contained within the screen. Thus, the content reproduction application 202 subjects the video to a process of simplifying the GUI and displaying the simplified GUI. Specifically, the content reproduction application 202 eliminates a part of objects in the GUI in a first display mode, and displays the GUI, from which the part of the objects has been eliminated, in a second display mode.

The screen 423 displays a video image which has been subjected to a process of eliminating a part of items in a menu (e.g. some unnecessary items or some items with low frequency of use), thereby changing the menu to a menu including only the remaining items. It is estimated that when 3D content is being played back, the possibility is low that the user performs a complex operation by using a GUI. Thus, the content reproduction application 202 executes a process of simplifying display of those objects in the GUI, which are not needed or are not frequently used. The screen 423 displays the menu including two items, which is obtained by eliminating four unnecessary or rarely used items from the six items in the menu displayed on the screen 422. Thereby, the visibility of the GUI can be improved while an increase in the number and size of objects (e.g. menu items) in the GUI is being suppressed.

FIG. 7 shows a screen 431 in which a background color with a low brightness is set. The GUI display change module 305 sets the brightness of the background of the GUI in the second display mode to be lower than the brightness of the background of the GUI in the first display mode, and displays the GUI with the lower brightness of the background. The GUI display change module 305 subjects the video to, for example, a process of changing the background color from white to a color with a lower brightness (e.g. black). As shown in the screen 431, by changing the background color to the color with a lower brightness, the black scanning line, which appears in every other row, becomes less conspicuous, and the flicker perceived by the user can be reduced. For the purpose of description, in FIG. 7, the background color of the entire window is changed. Alternatively, only the background color of the region corresponding to the GUI may be changed, and the background color, which is designated by 3D video (3D content), may be used as such for the region corresponding to the 3D video (3D content).

The above-described changing processes for changing the display mode of the GUI and background color may independently be executed on video, or may be executed on video at the same time. The changing process may be executed on the entire screen, or on only the region which is assumed to attract the user's attention. The examples of the region, which is assumed to attract the user's attention, include captions, a menu, an icon and a window set in an active state, and regions neighboring a mouse cursor or a caret. The region, which is to be subjected to the process of changing the display mode, may be a region of captions which are superimposed on 3D video, or a GUI, such as a menu or a pop-up, which is dynamically displayed in accordance with the user's instruction.

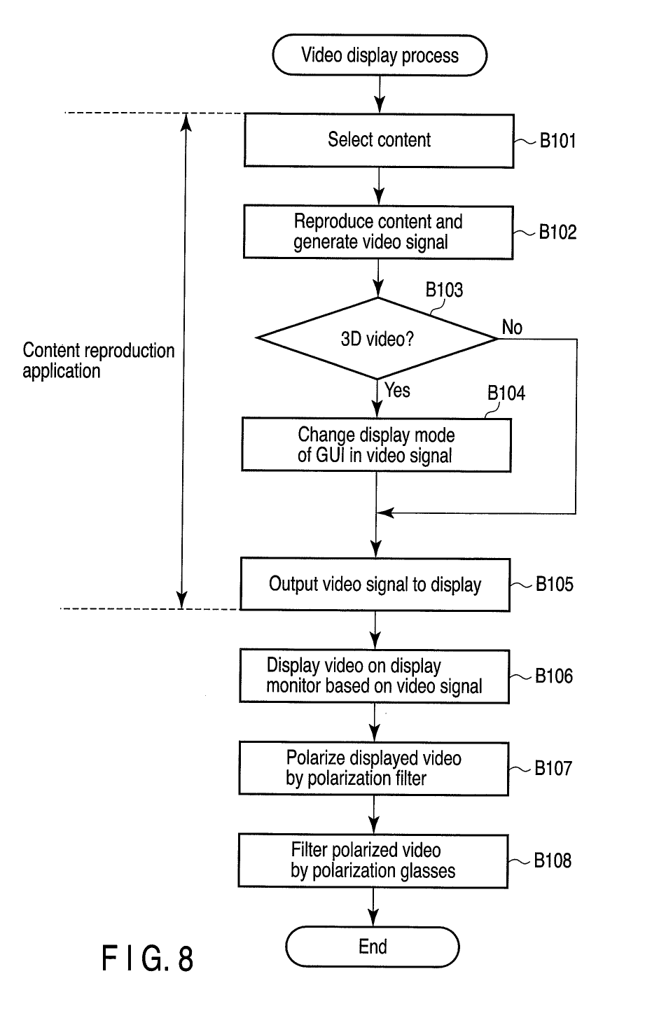

Next, referring to the flowchart of FIG. 8, a description is given of an example of the procedure of a video display process executed by the video display apparatus 10.

To start with, the content reproduction application 202 selects video content data that is the target of reproduction (the target video content data) (block B101). For example, the target video content data is designated by the user by using, e.g. a GUI. The content reproduction application 202 reproduces the target video content data, and generates a video signal of video which is to be displayed on the LCD 17 (block B102).

Subsequently, the content reproduction application 202 determines whether the target video content data is video content data for displaying 3D video (3D video content data) (block B103). Based on the target video content data or the generated video signal, the content reproduction application 202 determines whether the target video content data is 3D video content data. Alternatively, the content reproduction application 202 may determine whether the target video content data is 3D video content data, based on whether the video rendering method is set to be a method which supports viewing of 3D video by a polarization scheme.

If the target video content data is 3D video content data (YES in block B103), the content reproduction application 202 changes the display mode of the GUI in the generated video signal from a first display mode to a second display mode (block B104). The content reproduction application 202 subjects, for example, text in the GUI to a process of changing the font, a process of increasing the font size, a process of changing the font to a boldface font. In addition, the content reproduction application 202 executes a process of increasing the display size of objects, such as a button, an icon, a slider, a mouse cursor, a caret, a menu, a window, etc. The content reproduction application 202 generates a video signal which has been subjected to the above-described process of changing the display mode of the GUI.

After the process of changing the display mode of the GUI in the video signal has been executed, or if the target video content data is not 3D video content data (NO in block B103), the content reproduction application 202 outputs the generated video signal to the LCD 17 (block B105). In other words, the content reproduction application 202 outputs the video signal, which has been subjected to the process of changing the display mode of the GUI, to the LCD 17 if the target video content data is 3D video content data. The content reproduction application 202 outputs the video signal, which is based on the target video content data, directly to the LCD 17 if the target video content data is not 3D video content data.

Then, the LCD 17 displays video based on the input video signal (block B106). If the target video content data is 3D video content data, for example, the pixels of left-eye video are displayed on odd-numbered scanning lines and the pixels of right-eye video are displayed on even-numbered scanning lines.

The polarizing filter 19 polarizes the video displayed on the LCD 17 (block B107). For example, the polarizing filter 19 polarizes, in a first direction, the video corresponding to the odd-numbered scanning lines, and polarizes, in a second direction, the video corresponding to the even-numbered scanning lines. In other words, the polarizing filter 19 polarizes the left-eye video by the left-eye filter 19A and polarizes the right-eye video by the right-eye filter 19B.

The polarized glasses 31 pass the polarized left-eye video by the left-eye filter 31A, and passes the polarized right-eye video by the right-eye filter 31B (block B108). By viewing the polarized video with the polarized glasses 31, the user can view the left-eye video by the left eye and the right-eye video by the right eye. Thus, if the target video content data is 3D video content data, the user wears the polarized glasses 31 and views the polarized video, thus being able to view 3D video. Moreover, the user can easily operate the GUI, the visibility of which has been improved by the process of changing the display mode of the GUI.

By the above-described process, if the target video content data is 3D video content data, the visibility of the GUI rendered in the 3D video can be improved. Furthermore, it is determined whether the target video content data is 3D video content data (i.e. whether the polarized glasses 31 are in use or not), and the ON/OFF of the function of changing the display mode of the GUI is automatically switched. Thereby, the user can omit a procedure of setting at each time of use.

As has been described above, according to the present embodiment, the visibility of the GUI, which is rendered in the 3D video by the polarization scheme, can be improved. The content reproduction application 202 effects switching as to whether or not to change the display mode of the GUI, according to whether the target video content data is 3D video content data. If the target video content data is 3D video content data, the content reproduction application 202 executes the process of compensating the visibility of the GUI in the video. Specifically, the content reproduction application 202 can improve the visibility of the GUI, by subjecting the video to the process of changing the size of display of the GUI on the screen, the process of simplifying the GUI that is displayed, and the process of changing the background color.

If the difficulty in viewing video, such as flickering, occurs due to the display of 3D video by the polarization scheme, the content reproduction application 202 can execute the above-described display mode changing process to any object in the video, as well as the GUI.

All the procedures of the video display process according to the present embodiment may be executed by software. Thus, the same advantageous effects as with the present embodiment can easily be obtained simply by installing a program, which executes the procedures of the video display process, into an ordinary computer through a computer-readable storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display apparatus comprising:
a video generation module configured to generate video comprising left-eye video and right-eye video by using video content data;
a display mode changing module configured to change a display mode of a graphical user interface in the video from a first display mode to a second display mode;
a display configured to display the video; and
a polarizing filter covering a screen of the display and configured to polarize the displayed left-eye video and the displayed right-eye video.

2. The video display apparatus of claim 1, further comprising a determination module configured to determine whether the video content data is video content data for displaying three-dimensional video,
wherein the display mode changing module is configured to change the display mode of the graphical user interface in the video, if the determination module determines that the video content data is the video content data for displaying three-dimensional video.

3. The video display apparatus of claim 1, wherein the display mode changing module is configured to display, in the second display mode, each object in the graphical user interface with a larger size than in the first display mode.

4. The video display apparatus of claim 1, wherein the display mode changing module is configured to set a font size of text in the graphical user interface larger in the second display mode than in the first display mode.

5. The video display apparatus of claim 1, wherein the display mode changing module is configured to change a font of text in the graphical user interface to a boldface font in the second display mode.

6. The video display apparatus of claim 1, wherein the display mode changing module is configured to display the graphical user interface from which a portion of objects in the graphical user interface in the first display mode is eliminated in the second display mode.

7. The video display apparatus of claim 1, wherein the display mode changing module is configured to set a background color of the graphical user interface to be a background color with a lower brightness in the second display mode than in the first display mode.

8. The video display apparatus of claim 1, wherein the left-eye video and the right-eye video polarized by the polarizing filter are viewed by using polarized glasses comprising a first filter configured to pass the polarized left-eye video and a second filter configured to pass the polarized right-eye video.

9. A video display method for presenting three-dimensional video by a polarization scheme, comprising:
generating video comprising left-eye video and right-eye video by using video content data; and
changing a display mode of a graphical user interface in the video from a first display mode to a second display mode.
